(19) United States
(12) Patent Application Publication
(10) Pub. No.: US 2007/0068244 A1
(43) Pub. Date: Mar. 29, 2007

(54) Measuring forces in athletics

(75) Inventors: Daniel Billing, Victoria (AU); Jason Hayes, Victoria (AU); Romesh Nagarajah, Victoria (AU)

Correspondence Address: CONNOLLY BOVE LODGE & HUTZ LLP, P.O. BOX 2207, WILMINGTON, DE, 19899-2207, US

(73) Assignee: M.B.T.l. Limited, Hawthorn (AU)

(21) Appl. No.: 10/576,100

(22) PCT Filed: Oct. 15, 2004
(86) PCT No.: PCT/AU04/01407

§ 371 Date: Jul. 10, 2006

(30) Foreign Application Priority Data
Oct. 17, 2003 (AU) 2003905682

(51) Int. Cl. G01M 19/00

(52) U.S. Cl. 73/172

(57) ABSTRACT

A system for measuring ground reaction force and analyzing the performance of an athlete in which force sensors are located in the athletes shoe and a three dimensional accelerometer is located adjacent the athletes centre of gravity and the signals from the accelerometer and the force sensors are recorded and used to derive the three orthogonal components of the ground reaction force (GRF). An artificial neural network is used to derive the three orthogonal components of GRIF

This invention relates to the measurement of forces in athletics and in particular the measurement of ground reaction forces.

### BACKGROUND TO THE INVENTION

The feet form the human body's force transfer interface and offer more leverage for improving athletic performance than any other part of the body. That is, an athlete's most efficient means of utilizing force from muscular contraction for running is through foot contact with the ground. Ground reaction force (GRF), as the name suggests, is the force that reacts to the action force transmitted to the ground by the support limb of the runner. In accordance to Newton's third law, GRF is equal in magnitude and opposite in direction to the ‘action’ force. Force platforms, embedded in the surface of a runway, are the ‘gold standard’ contact measurement technique for the collection of the three orthogonal component GRF data. However, this technique requires that data is collected in a laboratory environment and factors such as targeting, limited successive foot contacts and straight line movement limit the knowledge that can be gained by this form of measurement system.

GRF as measured by a force plate is a resultant force. During foot contact force acts over the entire contact surface between foot and ground. The distribution of the GRF is not homogenous and more force is taken by some parts of the contact surface than others. In recent years techniques based on measuring pressures have become more widely used, where the distributed force is measured over the area of the foot-shoe interface using miniature electromechanical transducers. This form of wearable, in-shoe instrumentation has the advantage of allowing measurements to be taken in the training and competition environment where multiple footsteps can be collected. These systems measure pressure normal to their surface and are subjective or relative measurement devices in that their output is moderated by boundary conditions, in particular, surrounding media. Many attempts have been made to develop in-shoe sensors capable of determining the horizontal force components but due to friction at this site, non-planar force distribution, the deformable shoe reference frame, and the influence of a multitude of boundary conditions these attempts have been unsuccessful.

U.S. Pat. No. 6,195,921 discloses an electronic module and flexible sensor mat for measuring pressure at all points of the sole.

EP 0846441 discloses a system for determining the vertical component of the interaction force between foot and ground using a sensor matrix in the shoe sole which are communicated to a processing unit worn on the athletes belt.

WO 00/33031 discloses a shoe having a piezo pressure sensor device and an accelerometer in the shoe.

U.S. Pat. No. 6,243,659 discloses a system which utilizes a pair of master/slave units, one in each shoe. The slave transmits data from one shoe the master unit in the other shoe. The extent to which the signals are received is proportional to the distance between the emitter and receiver and is used as the basis for measuring speed and distance. Pressure sensors are used to time the emission of signals.

U.S. Pat. No. 6,216,545 discloses an array of piezo pressure sensors in a flexible polymer laminate that measures shear forces in two perpendicular directions.

U.S. Pat. No. 6,301,964 discloses a shoe attachment incorporating two accelerometers for analyzing gait kinematics for a stride.

WO 99/44016 discloses a basic version of an accelerometer based device for measuring stride length average and maximum speed and distance traveled.

U.S. Pat. No. 6,052,654 discloses a system using accelerometers that can measure foot contact and foot lift times and calculate pace. U.S. Pat. No. 6,298,314 discloses a system using motion sensors and timers to sense foot contact. Application WO 01/14889 discloses a low cost accelerometer.

U.S. Pat. No. 6,122,340 relates to a detachable device for a shoe incorporating accelerometers.

U.S. Pat. No. 6,122,960 discloses a system using accelerometers and rotational sensors and a transmitter to send distance and height information to a wristwatch to display speed distance traveled and height jumped. It also discloses the use of neural networks.

U.S. Pat. No. 6,167,356 discloses a system using accelerometers for measuring hang time for a jump.

This invention has the object of providing an unobtrusive, on athlete instrumentation to simultaneously acquire GRF and in-shoe load data.

### BRIEF DESCRIPTION OF THE INVENTION

To this end the present invention provides a system for measuring ground reaction force and analyzing the performance of an athlete in which force sensors are located in the athletes shoe and a three dimensional accelerometer is located adjacent the athletes centre of mass and the signals from the accelerometer and the force sensors are recorded and used to derive the three orthogonal components of the ground reaction force (GRF).

This invention is based on the realization that shoe based systems are not suitable to derive all of the force measurements because the sensors are too removed from the athletes centre of mass.

Newton's second law states that a body with a net force acting on it will accelerate in the direction of that force, and that the magnitude of the acceleration will be proportional to the magnitude of the net force. This law applied to the running domain means that GRF reflects the acceleration of the entire body centre of mass (CoM). Therefore if the centre of mass (CoM) is a singie point that represents the mass of all the body's segments, the vertical component of GRF is:
Fᵥ=m(aᵥ−g)

Where m is the total body mass, aᵥ, is the vertical acceleration of the centre of mass, and g is the acceleration due to gravity. Similarly the anterior-posterior and medio-lateral components of GRF may be represented as the total body mass times the acceleration of the centre of mass. That is:
F_{AP}=ma_{AP}
F_{ML}=ma_{ML}

Therefore the application of a three orthogonal component accelerometer applied to a site approximating the athlete's CoM provides a non-contact means to reference GRF.

Based on this insight the present invention provides an unobtrusive, wearable instrumentation system to simultaneously acquire contact (in-shoe load) and non-contact (CoM acceleration) references to GRF. The instrumentation is able to measure basic performance characteristics such as contact time, stride frequency, and peak pressure. In order to determine GRF it is preferred that a suitably trained artificial neural network (ANN) is utilised to determine GRF from unobtrusive, wearable instrumentation.

The instrumentation may be varied to increase the sampling frequency of the system to accurately capture high frequency impact events and enhancements to simultaneously acquire in-shoe load data from both feet. The ability to collect simultaneous CoM acceleration, in-shoe load and GRF enables coaches and researchers to investigate analytical relationships in the data.

The data processor is conveniently incorporated in a unit with the accelerometers on the back of the athlete adjacent the centre of mass. The load sensors in the shoes may be piezo devices and can be connected by wires to the processor or may communicate with it by any wireless transmission such as blue tooth protocol.

### DETAILED DESCRIPTION OF THE INVENTION

Preferred embodiments of the invention will be described with reference to the drawings in which

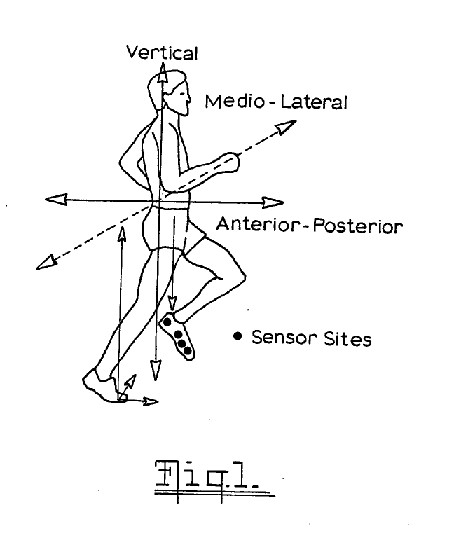

FIG. 1 illustrates the placement of the sensors used in this invention;

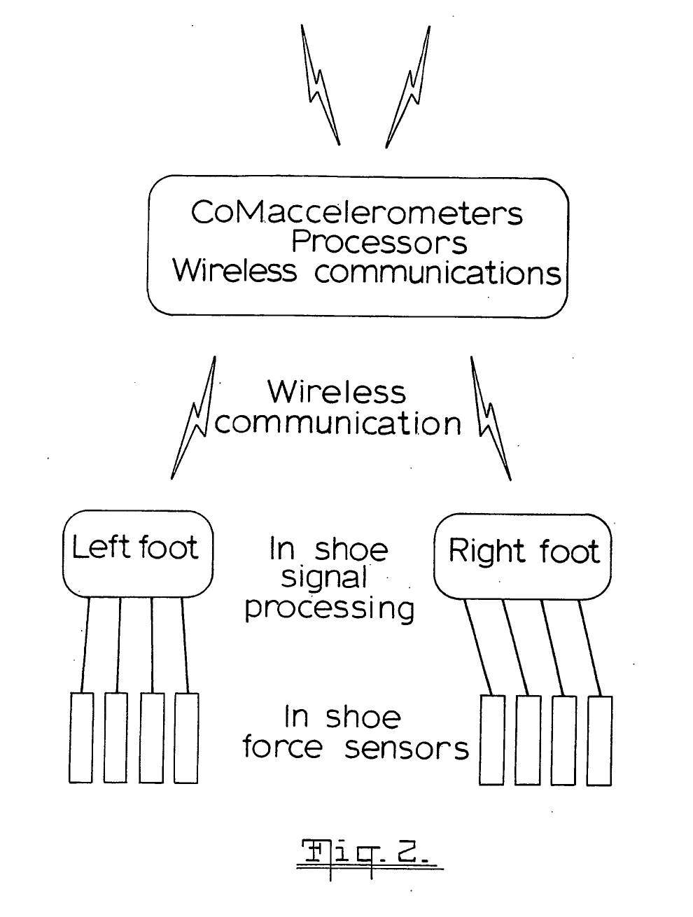

FIG. 2 illustrates the schematic arrangement of the sensors and the communication arrangement;

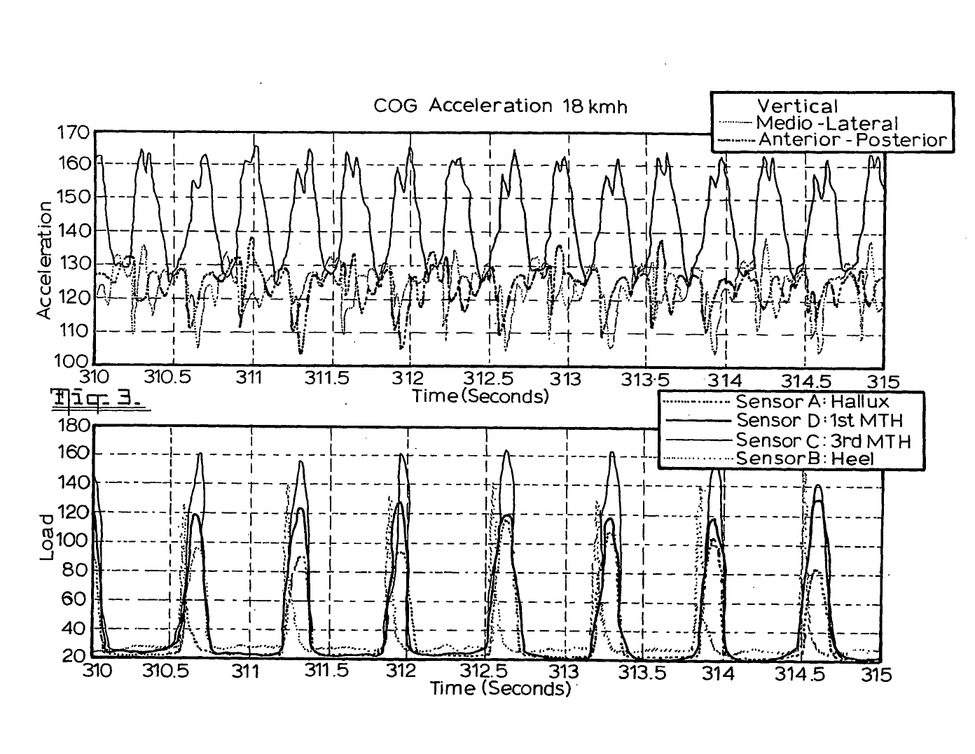

FIG. 3 illustrates graphically the accelerometer and in shoe sensor data;

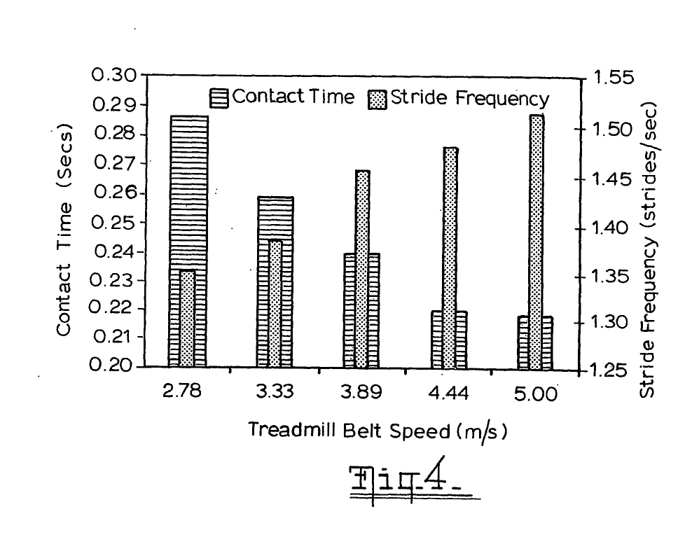

FIG. 4 illustrates the contact time and stride frequency as a function of running speed;

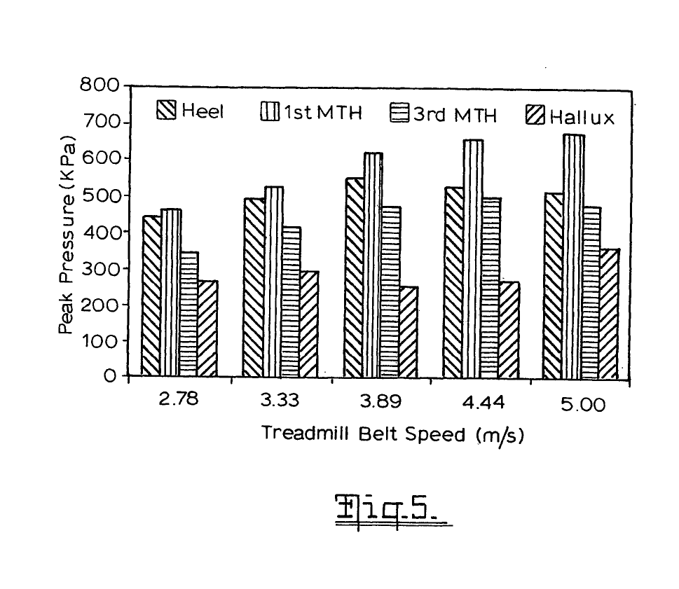

FIG. 5 illustrates the peak pressure for different sensors as afunction ofrunning speed;

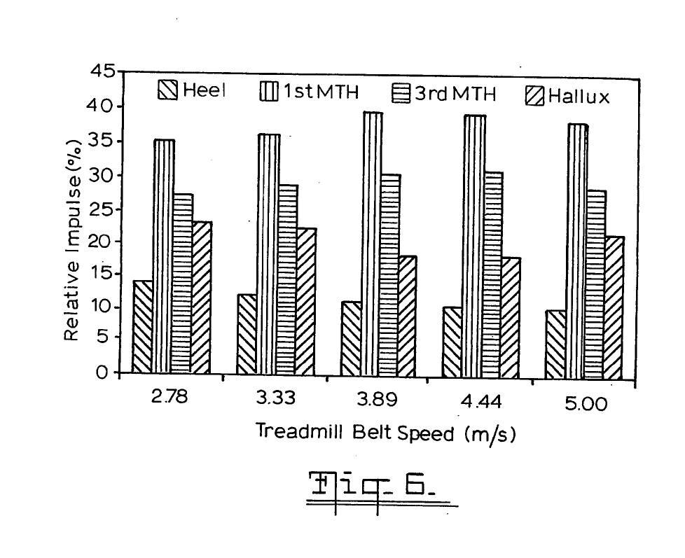

FIG. 6 illustrates relative impulse (%) as a function of running speed for different sensors.

FIGS. 1 and 2 illustrate a portable data acquisition system developed to simultaneously acquire load data from four discrete in-shoe hydrocell sensors deployed at the major anatomical support structures of the foot (heel, first metatarsaolhead, thrdmetatarsal head and hallux) and three channels of acceleration measured at a site approximating the athletes centre of mass attached to the small of the back. Wireless communication occurs between the in shoe signal processors which collect data from the four in shoe sensors and the central athlete processor located adjacent the accelerometer at the athletes centre of mass.

FIG. 3 illustrates data collected whilst running on a treadmill at 5 ms⁻¹. In-shoe load sensors are applied to the left foot only in this illustration. As can be seen from this figure the simultaneous collection of in-shoe load data and centre of mass acceleration opens new methods to analyse human performance.

Device Construction and Design

The device design is based on the principle that the device is unobtrusive and light preferably below 150 grams so that the athlete is effectively unaware of its presence.

The main electronics module is shaped for location at the medial lumbar region of the athletes back. The module is incorporated into a semi elastic belt and fastened over the L3-L4 invertebral space which approximates the centre of mass of a human subject. The electronics module consists of a battery-operated microprocessor with an 8 bit analog-to-digital converter, a 32 megabit multimedia memory card (MMC) for data storage and a serial transceiver to facilitate communication with a host computer. Surface mounted integrated circuit technology on a two-layer printed circuit board is employed. Two dual axis, ±2 g Analog Devices accelerometers (ADXL202E) are mounted to the surface of the main electronics module and aligned perpendicular to each other thereby creating a three orthogonal component accelerometer system. The micro processor is programmed to acquire data from each sensor at a rate of 500 Hz. Interfaced to the the main electronics module is a separate signal conditioning circuitry module for the in-shoe load sensors. The in-shoe load sensors are commercially available (paromed Vertriebs GmbH & Co. KG) piezoresistive microsensors embedded into water-filled hydrocells or preferably silicone filled bladders. The sensor element consists of a silicon micromachined membrane with implanted resistors. Due to this configuration the pressure measured by the sensors is associated with resultant forces and cannot be resolved into directional components. Sensors are deployed to the foot shoe interface at four major anatomical support structures namely the heel, first metatarsal head, third metatarsal head and hallux. The in-shoe load sensors are connected to the signal conditioning circuitry module, located at the small of the subject's back, via a flexible wiring harness or preferably by wireless technology such as blue tooth.

The microprocessor runs at a clock frequency of 9.83 MHz with a 3.3 volt power supply. It features eight ADC input channels of which three are used for measuring acceleration and four are used to measure in-shoe load. Every time an interrupt occurs readings are taken from the three acceleration sensors and the four in-shoe load sensors and stored in the memory input buffer. When the input buffer of the MMC is filled it is written to the nonvolatile cells in the MMC. In each case the signal conditioning circuitry maps the operating characteristics of the given sensor to a voltage in the 0-3.3V range of the microprocessors analog-to-digital converters.

Validity and Reliability Testing

In-shoe load sensors have been evaluated in terms of linearity, intra and inter sensor tolerance and hysteresis using Zwick tensilometer machine. The calibration of the in-shoe load sensors ensures equivalent output among all sensors when a given force is applied, so that the relative differences in pressure can be determined. To illustrate the non-linear behavior introduced to the sensor output as a result of the surrounding media a series of Zwick tests have been undertaken where the sensor is placed between different density and thickness EVA materials.

Data Collection During Running

In order to functionally evaluate the instrumentation a range of treadmill running tests have been performed for a single subject (Age: 26, Height: 183 cm, Mass: 78 kg). Treadmill belt speeds of 2.78 ms⁻¹, 3.33 ms-1, 3.89 ms⁻¹, 4.44 ms⁻¹ and 5.00 ms⁻¹ were employed. Data was logged at a rate of 125 Hz per channel over a 60 second period for each treadmill belt speed with the sample period commencing as soon as the target belt speed was reached and the subject settled into a consistent running pattern. Seven strides were selected during each running speed for further analysis. In-shoe load sensors were deployed to the subjects shoe inner at the major anatomical load bearing structures of the foot (heel, first metatarsal head, third metatarsal head and hallux). Three orthogonal components of acceleration were measured from the small of the subjects back (CoM).

Results

CoM acceleration and in-shoe load data collected simultaneously provide an illustration of the cyclic nature of running and a number of basic performance parameters may be readily identified in each data set. FIG. 4 provides an illustration of contact time and stride frequency, determined from in-shoe load data, for the five different running speeds under investigation.

Of particular interest is the timing of events that can be seen through the simultaneous collection of CoM acceleration and in-shoe load data. Firstly, the event of heel strike seems to be followed by sharp spikes in the medio-lateral and anterior-posterior acceleration waveforms. That is, heel strike is accompanied by a sharp deceleration in the body CoM. It is interesting to note also that heel strike is accompanied by a sharp upward or downward spike in the medio-lateral acceleration waveform that is dependant on left (downward) or right (upward) foot strike. This possibility to distinguish left and right foot contact through an analysis of the medio-lateral acceleration waveform has been reported in previous literature. FIG. 5 illustrates regional peak pressure recorded for the running speeds under investigation. Along with determining regional peak pressure, regional impulse is determined by integrating the local forces under the specific anatomical landmarks throughout foot contact. FIG. 6 illustrates the regional impulse as a percentage of the sum of all impulse values.

As illustrated in FIG. 4 stride frequency increases as a function of increasing running speed and alternatively contact time decreases as a function of increasing running speed. For each running speed under investigation the highest peak pressures have been recorded at the site of the first metatarsal head with peak pressure at this site increasing as a function of increasing running speed. The lowest peak pressure for all running speeds was recorded at the site of the hallux. Relative impulse at the heel decreases as a function of increasing running speed as load migrates to the forefoot. The lack of other systematic trends in relative impulse analysis may be due to the fact that although peak pressures may be greater for increasing running speed for specific sensors the duration of loading (contact time) decreases. This phenomena has also been observed in related literature.

There are a number of problems that need to be considered when deploying the aforementioned instrumentation to the human subject. First, in-shoe load sensors measure subjecitve or relative load to their surface. A multitude of internal and external boundary conditions influence data collected at the foot-shoe interface. From an internal perspective the structural and functional aspects of the foot, shoe construction features, and material properties influence these measurements. External factors such as running speed, running surface, running technique and body weight will also influence measurement at the foot-shoe interface. Non-planar force distribution and within shoe friction are also significant factors influencing measurements at the foot-shoe interface.

Similarly, in measuring CoM acceleration there are a number of problems to be aware of. The small of the subjects back, where the accelerometer instrumentation is deployed is an approximation of the subjects CoM. Also, as the accelerometers are attached to soft tissue and this tissue moves with respect to bone, undesirable acceleration signals may be present. Acceleration measured at the CoM of the human body provides a signal that is composed of a translational, rotational, and a gravitational component. This implies that at any instant errors may be present due to the unknown relationship between gravity and the athlete's frame of reference to the accelerometers frame of reference.

However, even in the presence of the above mentioned measurement problems it is envisioned that complex and unique interactions will exist between CoM acceleration and in-shoe load to the three orthogonal components of GRF, which appear difficult to model analytically. Therefore, in order to circumvent the individual disadvantages of the unobtrusive, wearable instrumentation that has been developed and to provide a means to determine GRF, the application of artificial neural networks (ANN) has been applied to this problem. An ANN can be likened to a flexible mathematical function, which has many configurable internal parameters. To accurately represent complicated relationships among CoM acceleration and in-shoe load (inputs) to the three orthogonal components of GRF (target), these internal parameters need to be adjusted through an optimization or so-called learning algorithm. To train the ANN, inputs and corresponding targets are simultaneously presented to the network, which iteratively self-adjusts to accurately represent as many examples as possible. A training algorithm is used to iteratively adjust the internal network parameters such that an optimal mapping is provided between input and target data.

A feed-forward back propagation neural network architecture was used because this is the most commonly used in measuremet applications. The network consisted of three layers: an inpit layer, hidden layer and an output layer. The optimal ANN architecture to predict the vertical component of GRF was a network of 8 input layer units, 4 hidden layer units and 1 output layer. The optimal ANN architecture to predict the anterior-posterior component of GRF was a network of 4 input layer units, 2 hidden layer units and 1 output layer. The log-sigmoid transfer function was employed in all 3 layers of the network because this is most commonly used in back propagation networks. The Lavenberg-Marcquadt Algorithm was employed as the network training algorithm.

Once the ANN is trained it can accept new inputs which it has not previously seen and attempt to predict the target variables. Successful Zwick tests have been conducted simulating in-shoe conditions where non-linear sensor output has been mapped using ANN to the Zwick tensilometer machine load cell.

From the above it will be realized that the present invention presents a unique method of measuring simultaneously CoM acceleration, in-shoe load and GRF. Those skilled in the art will realize that this invention may be implemented in embodiments other than those described without departing from the core teachings of this invention.

1. A system for measuring ground reaction force and analyzing the performance of an athlete in which force sensors are located in the athletes shoe and a three dimensional accelerometer is located adjacent the athletes centre of mass and the signals from the accelerometer and the force sensors are recorded and used to derive the three orthogonal components of the ground reaction force (GRF).

2. A system as claimed in claim 1 in which the sensor signals are used to derive ground reaction force by using an artificial neural network to derive the three orthogonal components of GRF.

3. A system as claimed in claim 1 in which centre of mass acceleration, in shoe load and ground reaction force are measured simultaneously.

4. An athlete monitoring system comprising
a) at least one force sensor in at least one shoe to sense in-shoe load
b) communication means associated with said force sensor
c) a tri-axial accelerometer adapted for location adjacent the athletes centre of mass
d) an electronics module including a receiver for receiving signals from said force sensor and a processor for processing signals from said force sensor and said accelerometer to derive ground reaction force from the in shoe load and centre of mass acceleration references to ground reaction force.

5. An athlete monitoring system as claimed. in claim 4 in which the communication from the force sensor to the electronics module is wireless.

6. An athlete monitoring system as claimed in claim 4 in which centre of mass acceleration, in shoe load and ground reaction force are measured simultaneously.

7. An athlete-monitoring system as claimed in claim 4 in which an artificial neural network is used to represent relationships between the in shoe load measurements and the centre of mass acceleration to the three orthogonal components of ground reaction force.

8. An athlete monitoring system as claimed in claim 4 wherein piezoresistive sensors are deployed at the major anatomical support structures in the foot as the in shoe force sensors.
